(19) United States
(12) Patent Application Publication
(10) Pub. No.: US 2005/0249343 A1
(43) Pub. Date: Nov. 10, 2005

(54) Method for conveniently adding contact information to a network-based address book

(76) Inventor: Oliver Birch, Annapolis, MD (US)

Correspondence Address: McGinn & Gibb, PLLC;Suite 304, 2568-A Riva Road, Annapolis, MD, 21401, US

(21) Appl. No.: 10/839,900

(22) Filed: May 6, 2004

(51) Int. Cl. H04M 1/64; H04M 1/56; H04M 15/06

(52) U.S. Cl. 379/142.01; 379/88.21; 379/88.19

(57) ABSTRACT

A method and structure for a communication device connected to the telephone network. A first database within the telephone network provides line identification information associated with a telephone call occurring on the communication device and a second telephone network database is used to maintain the telephone address book. An intelligent peripheral within the telephone network receives the line identification information. The intelligent peripheral is adapted to automatically store the line identification information in the telephone address book based on commands from the communication device.

### BACKGROUND OF THE INVENTION

1. Field of the Invention

The present invention generally relates to a method and system for automatically adding entries to a network-based address book using the caller information provided by a standard telephony network.

2. Description of the Related Art

A network-based address book resides in a service provider's telephony network rather than in a subscriber's telephone or other personal device. For example, Sprint Voice Command(^{SM}) (Sprint Corp., Kansas City, Mo., USA) stores a subscriber's personal address book in the network using an interface such as, for example, HTTP Web Interface. In the past, new contact information (name and telephone number) had to be manually entered into a network-based address book, usually through a web browser. The main problem with this approach is that subscribers often want to update their address books when they do not have access to the web. However, conventional systems require the user to be both sitting in front of a web browser and logged into the service provider's web site to update their address book. This problem is even more pronounced for mobile phone usage when users are unable to access a browser and/or active internet connection.

In reality, the subscribers rarely visit the service provider's web site and consequently rarely updated their address book. This causes a decline in the service usage over time as the address books get more and more out-of-date. Subscribers want to update their address books when they have the contact information directly at hand—most often when they are either making or receiving a telephone call, whether this is when they are at home, at work, in the car or just walking around. They also want to do the updating with little or no effort. The invention disclosed below addresses these concerns.

### SUMMARY OF THE INVENTION

This disclosure presents a method of creating and updating a telephone address book. The invention provides line identification information associated with a telephone call occurring on a communication device. This line identification information comprises caller identification (caller ID) information, including outgoing call information and incoming call information. The line identification information is supplied from a first telephone network database. The telephone address book comprises, for example, a voice activated telephone address book.

Without requiring the user to log on to a web site, the invention automatically stores the line identification information in the telephone address book. This process of automatically storing the line information is activated by the communication device that receives or sends the telephone call during the telephone call, at the end of the telephone call, or after the telephone call.

The telephone address book is located in a portion of a second telephone network database and the first telephone network database and the second telephone network database comprise portions of a telephone switching network separate from the communication device receiving/sending the telephone call.

The system disclosed below includes a communication device connected to the telephone network. A first database within the telephone network provides line identification information associated with a telephone call occurring on the communication device and a second telephone network database is used to maintain the telephone address book. An intelligent peripheral within the telephone network receives the line identification information. The intelligent peripheral is adapted to automatically store the line identification information in the telephone address book based on commands from the communication device.

This disclosure identifies a method whereby after a subscriber has made or received a telephone call, he/she can easily add the called or calling party's telephone number and name to the subscriber's network-based address book. This method adapts the standard telephony network infrastructure to send the caller ID/name of the called or calling party to an adjunct processor that stores a historical list of calls with the caller ID/name in a subscriber database. The subscriber can then use a simple automated mechanism to move this information into their personal network-based address book. This allows subscribers to have a convenient and simple way to keep their contact information up-to-date without logging into the service provider's web site.

These, and other, aspects and objects of the present invention will be better appreciated and understood when considered in conjunction with the following description and the accompanying drawings. It should be understood, however, that the following description, while indicating preferred embodiments of the present invention and numerous specific details thereof, is given by way of illustration and not of limitation. Many changes and modifications may be made within the scope of the present invention without departing from the spirit thereof, and the invention includes all such modifications.

### BRIEF DESCRIPTION OF THE DRAWINGS

The invention will be better understood from the following detailed description with reference to the drawings, in which:

FIG. 1 is a schematic diagram of a telephone network system;

FIG. 2 is a schematic diagram of a telephone network system; and

FIG. 3 is a flow diagram illustrating a preferred method of the invention.

### DETAILED DESCRIPTION OF PREFERRED EMBODIMENTS OF THE INVENTION

The present invention and the various features and advantageous details thereof are explained more fully with reference to the nonlimiting embodiments that are illustrated in the accompanying drawings and detailed in the following description. It should be noted that the features illustrated in the drawings are not necessarily drawn to scale. Descriptions of well-known components and processing techniques are omitted so as to not unnecessarily obscure the present invention. The examples used herein are intended merely to facilitate an understanding of ways in which the invention may be practiced and to further enable those of skill in the art to practice the invention. Accordingly, the examples should not be construed as limiting the scope of the invention.

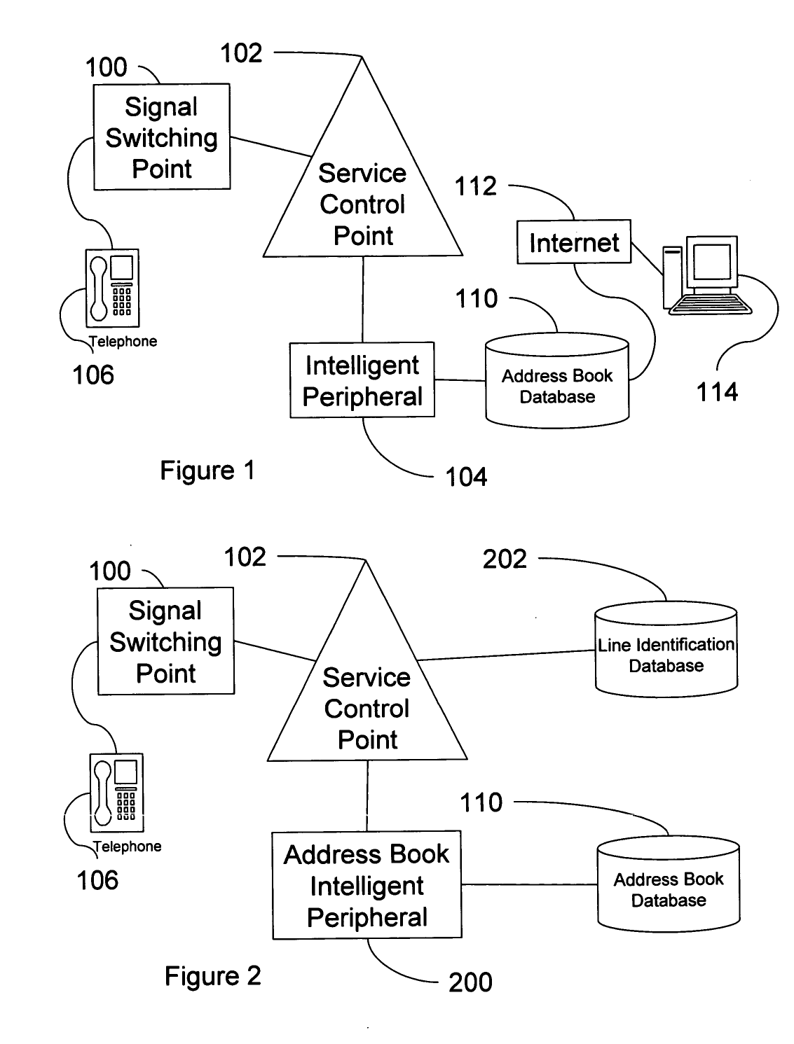

With the invention, a telephony network is adapted to store caller ID and/or name. More specifically, FIG. 1 is a block diagram that schematically illustrates a wired or wireless communication device 106 in a telephone network that is configured for provision of IN services. While the communication device 106 shown in the drawings is a telephone, the invention is applicable to any device capable of voice communication, including but not limited to cellular phones, land line phones, wireless phones, voice enabled personal digital assistants (PDAs), voice enabled computers, etc. The telephone 106 is directly or indirectly connected to a signal switching point 100, receives signaling and voice communications from the communication device 106, and transfers the communications to other network elements in order to complete and carry out calls made by or to the communication device 106.

The signal switching point 100 provides basic switching capabilities, including the means to establish, manipulate and release calls and connections. When signaling passing through the signal switching point 100 is related to an IN service, the call is suspended temporarily and control of the call is passed to the service control point (SCP) 102. Communications between SSP 100 and SCP 102 are based on a standard IN Application Protocol (INAP). The SCP 102 processes the call, and then sends instructions back via INAP to SSP 100 as to how the call should be handled.

One basic idea of IN is to move intelligent services out of the network switches to separate service points, such as SCP 102. Multiple SCPs may communicate with a given signal switching point, or the switch can be programmed to choose the SCP for each call depending on the trigger parameters. Similarly, a single SCP can communicate with and service multiple SSPs (although not all the switches in a network are necessarily IN-enabled). The unified IN architecture allows different service providers to create SCPs and IPs that implement their own particular services, independent of the underlying network technology.

Thus, the signal switching point 100 directs calls according to instructions from the service control point (SCP) 102. The service control point 102 can also invoke the assistance of intelligent peripherals, such as intelligent peripheral 104. These intelligent peripherals are used to perform functions outside normal switching functions such as voice activated dialing, address book peripheral, etc. In the situation shown in FIG. 1, the intelligent peripheral is connected to an address book database 110. In the system shown in FIG. 1, the address book database 110 is updated through a browser interface (e.g., personal computer) 114 through an Internet 112 or similar connection. As mentioned above, having to update the address book 110 through a browser based Internet connection is cumbersome and often not utilized by the user.

Therefore, in the system shown in FIG. 2, a new type of intelligent peripheral identified as an address book intelligent peripheral 200 is utilized with the invention. In addition, the invention connects the service control point 102 to a line identification database (LIDB) 202 so that caller identification and other similar information can be transferred from the service control point to the address book intelligent peripheral 200.

With this system, the invention provides line identification information associated with a telephone call occurring on (to or from) the communication device 106. This line identification information can comprise caller identification (caller ID) information (e.g., names, addresses, telephone numbers, etc.) of the incoming or outgoing call. The line identification information is supplied from a first telephone network database 202. The telephone address book 200 comprises, for example, a voice activated telephone address book.

Without requiring the user to log on to a web site, the invention automatically stores the line identification information in the telephone address book 200. This process of automatically storing the line information is activated by the communication device that receives the telephone call and can occur during the telephone call, at the end of the telephone call, or after the telephone call.

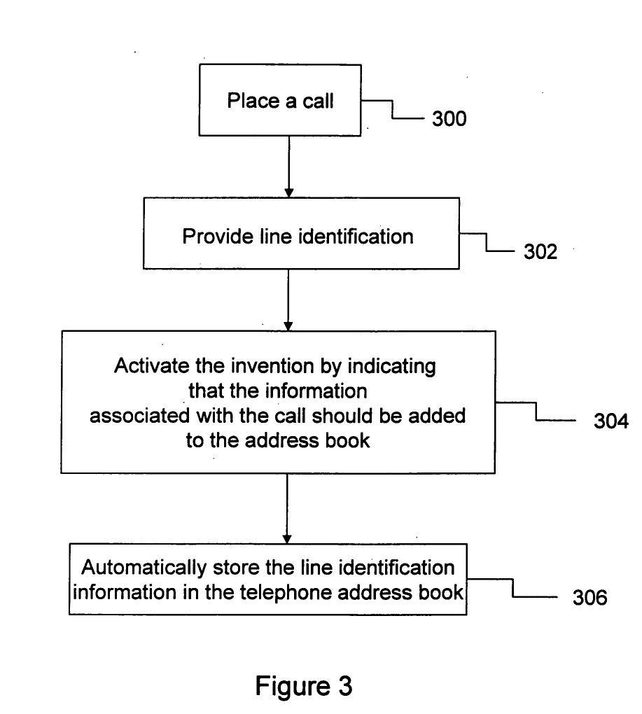

FIG. 3 shows the invention in flowchart form as a method of creating and updating a telephone address book. First, in item 300, a call is placed. Then, in item 302, the invention provides line identification information associated with a telephone call occurring on a communication device. This line identification information comprises caller identification (caller ID) information, including outgoing call information and incoming call information. The line identification information is supplied from a first telephone network database. The telephone address book comprises, for example, a voice activated telephone address book. Without requiring the user to log on to a web site, the user activates the invention by indicating (through the communication device) that the information associated with the call should be added to the address book (304). This process of automatically storing the line information is activated by the communication device that receives the telephone call, either during the telephone call, at the end of the telephone call, or after the telephone call. The invention then automatically stores the line identification information in the telephone address book (item 306).

The telephone address book is located in a portion of a second telephone network database and the first telephone network database and the second telephone network database comprise portions of a telephone switching network separate from the communication device receiving the telephone call. Thus, the system disclosed above includes a communication device 106 connected to the telephone network 100-202. A first database 202 within the telephone network provides line identification information associated with a telephone call occurring on the communication device 106 and a second telephone network database 200 is used to maintain the telephone address book. An intelligent peripheral 200 within the telephone network receives the line identification information. The intelligent peripheral 200 is adapted to automatically store the line identification information in the telephone address book 110 based on commands from the communication device 106.

With the invention, there are many call scenarios. For example, a call can be made to a subscriber, in which case a terminating address trigger is used to suspend the call while an SCP 102 is engaged, or the subscriber makes a call, in which case an originating address trigger is used, again suspending the call while an SCP 102 is engaged. In both cases the SCP 102 receives a Transaction Capabilities Application Part (TCAP) query containing at least either the called or calling number. In some networks the calling party name is also provided, but in networks where this is not available or when a call is originated, the SCP 102 makes a LIDB 202 dip to retrieve the caller name based on the called or calling party ID as appropriate. The SCP 102 then packages the subscribers ID, the called or calling party's ID and the called or calling party's name in a GDI query to an adjunct processor 200 such as a service node or intelligent peripheral. The adjunct processor 200 stores the information in the subscriber database 110.

There are then many possible mechanisms that could be used to move this information to the subscriber's address book within the database 110. This may include: the subscriber elects to automatically add all inbound and/or outbound calls to their address book—in this case the adjunct processor moves the contact information straight into the subscriber's address book (checking first if the record already exists).

The intelligent peripheral 200 provides a number of different ways to determine whether a particular telephone call will be used to store information within the address book (304). For example, the invention can be set so that every call is stored in the address book. Alternatively, the communication device can include one or more buttons that, when pressed, automatically cause the names and addresses associated with the current or most recent call to be added to the address book (e.g., single button, one-touch storing of names, numbers, addresses, etc.). In addition, the invention can provide the user with the option of responding to a machine-generated sound or question regarding whether the current or most recent telephone call information should be added to the address book, to which the user may respond verbally or through various keypad inputs.

This aspect of the invention substantially simplifies the creation of names, addresses, telephone numbers, etc. within the address book, thereby increasing the users the ability to enjoy the benefits of the address book. In addition, this process increases the accuracy of the information within the address book because the names, addresses, telephone numbers, etc. are taken from a known good database (line identification database 202). Further, by adding new entries to the address book while the user is in possession of a voice recording device (the communication device, such as a telephone) and the user's unique pronunciation (oral signature) relating to voice activated dialing can be created simultaneously when adding new entries to the address book.

Thus, this disclosure identifies a method whereby during or after a subscriber has made or received a telephone call, he/she can easily add the called or calling party's telephone number and name to the subscriber's network-based address book. This method adapts the standard telephony network infrastructure to send the caller ID/name of the called or calling party to an adjunct processor that stores historical list of calls with the caller ID/name in a subscriber database. The subscriber can then use a simple automated mechanism to move this information into their personal network-based address book. This allows subscribers to have a convenient and simple way to keep their contact information up-to-date without logging into the service provider's web site. Service providers can deploy services which use the network-based address book (such as voice-activated dialing). Since the address book is up-to-date, the services are more compelling and drive more revenue.

While the invention has been described in terms of preferred embodiments, those skilled in the art will recognize that the invention can be practiced with modification within the spirit and scope of the appended claims.

1. A system for creating and updating a telephone address book, said system comprising:
a telephone network adapted to maintain said telephone address book;
a communication device connected to said telephone network;
a database adapted to provide line identification information associated with a telephone call occurring on said communication device; and
an intelligent peripheral adapted to store said line identification information in said telephone address book.

2. The system in claim 1, wherein said telephone network is separate from said communication device.

3. The system in claim 1, wherein said intelligent peripheral is activated to store said line identification based on commands from said communication device.

4. The system in claim 1, wherein said intelligent peripheral is automatically activated to store said line information one of: during said telephone call; at the end of said telephone call; and after said telephone call.

5. The system in claim 1, wherein said line identification information comprises caller identification (caller ID) information.

6. The system in claim 1, wherein said line identification information comprises one of outgoing call information and incoming call information.

7. The system in claim 1, wherein said telephone address book comprises a voice activated telephone address book.

8. A system for creating and updating a telephone address book, said system comprising:
a telephone network;
a communication device connected to said telephone network;
a first database within said telephone network adapted to provide line identification information associated with a telephone call occurring on said communication device; and
a second database within said telephone network adapted to maintain said telephone address book; and
an intelligent peripheral within said telephone network adapted to store said line identification information in said telephone address book.

9. The system in claim 8, wherein said telephone network is separate from said communication device.

10. The system in claim 8, wherein said intelligent peripheral is activated to store said line identification based on commands from said communication device.

11. The system in claim 8, wherein said intelligent peripheral is automatically activated to store said line information one of: during said telephone call; at the end of said telephone call; and after said telephone call.

12. The system in claim 8, wherein said line identification information comprises caller identification (caller ID) information.

13. The system in claim 8, wherein said line identification information comprises one of outgoing call information and incoming call information.

14. The system in claim 8, wherein said telephone address book comprises a voice activated telephone address book.

15. A method of creating and updating a telephone address book, said method comprising:
providing line identification information associated with a telephone call; and
automatically storing said line identification information in said telephone address book, wherein said telephone address book is located in a portion of a telephone network database.

16. The method in claim 15, wherein said telephone network database comprises a portion of a telephone switching network separate from a communication device handling said telephone call.

17. The method in claim 15, wherein said process of automatically storing said line information is activated by a communication device handling said telephone call.

18. The method in claim 15, wherein said process of automatically storing said line information is activated one of: during said telephone call; at the end of said telephone call; and after said telephone call.

19. The method in claim 15, wherein said line identification information comprises caller identification (caller ID) information.

20. The method in claim 15, wherein said line identification information comprises one of outgoing call information and incoming call information.

21. The method in claim 15, wherein said telephone address book comprises a voice activated telephone address book.

22. A method of creating and updating a telephone address book, said method comprising:
providing line identification information associated with a telephone call occurring on a communication device, said line identification information being supplied from a first telephone network database; and
automatically storing said line identification information in said telephone address book,
wherein said telephone address book is located in a portion of a second telephone network database.

23. The method in claim 22, wherein said first telephone network database and said second telephone network database comprise portions of a telephone switching network separate from said communication device handling said telephone call.

24. The method in claim 22, wherein said process of automatically storing said line information is activated by said communication device handling said telephone call.

25. The method in claim 22, wherein said process of automatically storing said line information is activated one of: during said telephone call; at the end of said telephone call; and after said telephone call.

26. The method in claim 22, wherein said line identification information comprises caller identification (caller ID) information.

27. The method in claim 22, wherein said line identification information comprises one of outgoing call information and incoming call information.

28. The method in claim 22, wherein said telephone address book comprises a voice activated telephone address book.
